(19) United States
(12) Patent Application Publication
(10) Pub. No.: US 2015/0074336 A1
(43) Pub. Date: Mar. 12, 2015

(54) MEMORY SYSTEM, CONTROLLER AND METHOD OF CONTROLLING MEMORY SYSTEM

(71) Applicant: KABUSHIKI KAISHA TOSHIBA, Minato-ku (JP)

(72) Inventors: Hiroyuki NEMOTO, Yokohama-shi (JP); Yoshihisa KOJIMA, Kawasaki-shi (JP)

(73) Assignee: KABUSHIKI KAISHA TOSHIBA, Minato-ku (JP)

(21) Appl. No.: 14/206,377

(22) Filed: Mar. 12, 2014

Related U.S. Application Data
(60) Provisional application No. 61/875,921, filed on Sep. 10, 2013.

(51) Int. Cl. G06F 12/02

(52) U.S. Cl. CPC G06F 12/0246
USPC 711/103

(57) ABSTRACT

According to one embodiment, a log information generating unit generates log information that write logs are collected for each of data of a predetermined size, wherein the write log includes a change in a physical address relative to a logical address before and after writing to a write target by an atomic write process, and a process identifier that identifies the atomic write process. In a case where an interruption occurs in the atomic write process, and a memory system recovers from the interruption, a restoration processing unit extracts a first process identifier of the interrupted atomic write process, and restores address conversion information to a state before the atomic write process by using the write logs having the first process identifier.

### CROSS-REFERENCE TO RELATED APPLICATIONS

This application is based upon and claims the benefit of priority from U.S. Provisional Application No. 61/875,921, filed on Sep. 10, 2013; the entire contents of which are incorporated herein by reference.

### FIELD

Embodiments described herein relate generally to a memory system, a controller and a method of controlling the memory system.

### BACKGROUND

In a storage device that uses NAND type flash memory as a storage medium, changed contents of data storage position managing information that accompany data update in the storage medium were stored as logs.

### BRIEF DESCRIPTION OF THE DRAWINGS

FIG. 1 is a diagram illustrating an example of a configuration of a memory system according to an embodiment;

FIG. 2 is a diagram schematically illustrating units of data processing and units of position management in the NAND memory of the embodiment;

FIG. 3A is a diagram illustrating an example of the address conversion table as the management information;

FIG. 3B is a diagram illustrating an example of the valid clusters management table as the management information;

FIG. 4 is a diagram illustrating an example of the log information according to the embodiment;

FIG. 5 is a flow chart illustrating an example of a procedure of the rollback processing of the address conversion table according to the embodiment;

FIG. 6 is a flow chart illustrating an example of a procedure of the rollback processing of the address conversion table storage position information; and

FIG. 7 is a flow chart illustrating an example of a procedure of the rollback processing of the valid clusters management table according to the embodiment.

### DETAILED DESCRIPTION

In general, according to an embodiment, a memory system including a non-volatile first memory, a second memory, a third memory and a controller is provided. In the first memory, a position management of stored data is performed in a first size, access to data is performed in a second size being a natural number multiple of the first size, and erasure of data is performed in a third size being a natural number multiple of the second size. The second memory temporarily stores data transferred and received between a host device and the first memory, or data moved within the first memory. A third memory stores address conversion information that associates a logical address logically allocated within the first memory by the first size and a physical address physically allocated within the first memory by the first size in connection to the data to be stored in the first memory. The controller performs data transfer between the first memory and the second memory. Further, the controller includes a log information generating unit, a data processing unit, and a restoration processing unit. The log information generating unit generates log information that write logs are collected for each of data of a predetermined size. The write logs includes a change in the physical address relative to the logical address for each of position management unit data before and after writing of a write target by an atomic write process, and a process identifier that identifies the atomic write process, wherein the atomic write process completely writes the write target or returns the write target to a state in which the write target has not yet been written at all in a case where an interruption has occurred during the writing. The data processing unit writes a write data with the second size including the data that is to be a writing target of the atomic write process and the log information corresponding to the writing target in the first memory. The restoration processing unit extracts, in the case where the interruption occurs during the atomic write process and the memory system recovers from the interruption, a first process identifier appended to the interrupted atomic write process from the log information in the write data, and restores the address conversion information to a state before the atomic write process by using the write logs including the first process identifier.

Hereinbelow, a memory system, a controller, and a method of controlling a memory system of an embodiment will be described in detail with reference to the attached drawings. Note that the embodiment does not limit the present invention.

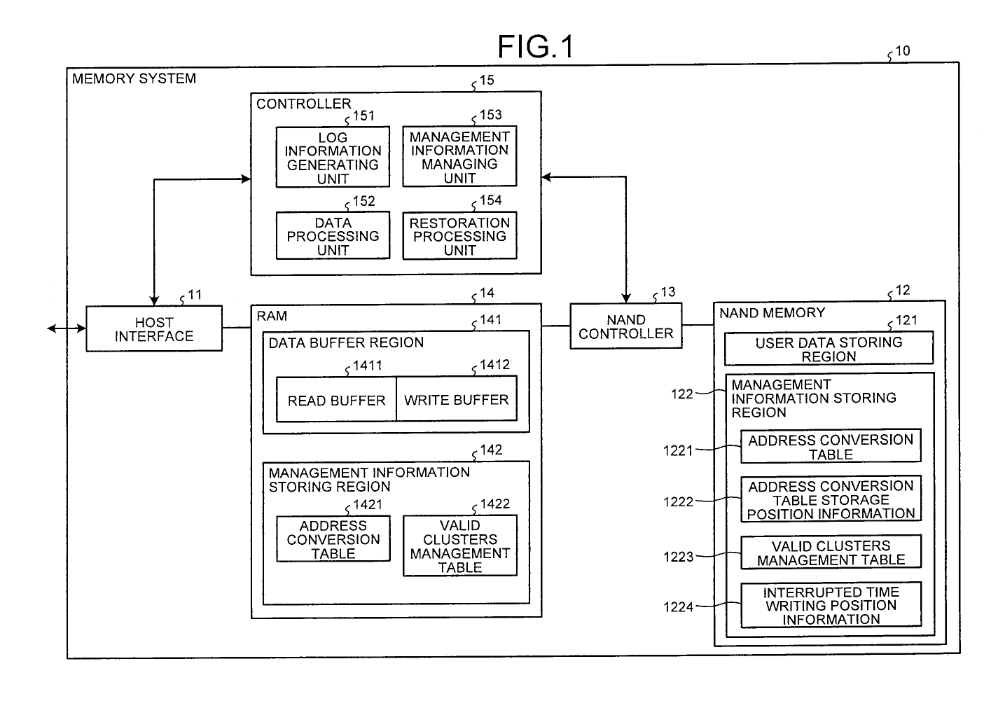

FIG. 1 is a diagram illustrating an example of a configuration of a memory system according to an embodiment. The memory system 10 is for example an SSD (Solid State Drive). Hereinbelow, a case of using NAND type flash memory (hereafter referred to as NAND memory) as nonvolatile memory will be given as an example.

The memory system 10 includes a host interface 11, NAND memory 12 that is a first memory, a NAND controller 13, RAM (Random Access Memory) 14 that is a second memory, and a controller 15.

The host interface 11 is an ATA (Advanced Technology Attachment) interface and the like, and is an interface with a host device that is not illustrated, such as a personal computer, a CPU (Central Processing Unit) core and the like.

The NAND memory 12 is a storage medium that can store data in a nonvolatile manner, and is used as a storage unit for archives for user data or program, or management information and the like that manages storing positions (storing positions) of data and the like within the memory system 10. Specifically, it includes a user data storing region 121 that stores data or program and the like designated on a host device side, and a management information storing region 122 that stores management information and the like that manages data storing positions in the NAND memory 12.

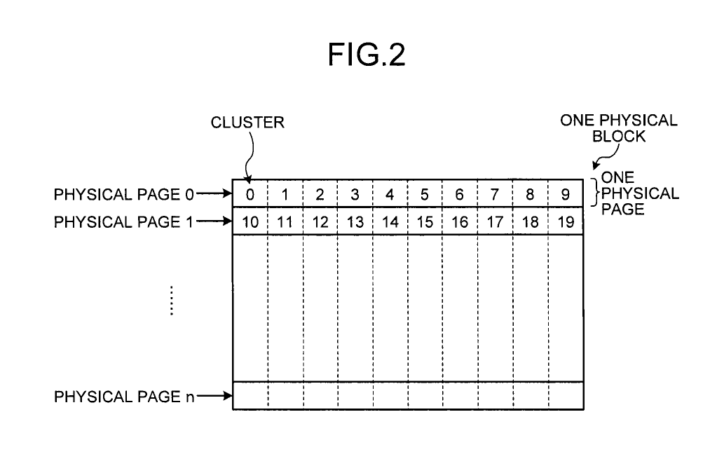

FIG. 2 is a diagram schematically illustrating units of data processing and units of position management in the NAND memory of the embodiment. In a chip configuring the NAND memory 12, a unit by which accesses for write and read can be performed is a physical page. A minimum unit configured of a plurality of physical pages, and by which a collective erasure can be performed is a physical block.

Further, physical addresses are allocated to units of clusters, which are units smaller than one physical page. Accordingly, an address conversion table described later that retains a corresponding relationship of logical addresses and physical addresses is managed in the units of clusters. A cluster size is a size that is a natural number multiple of a sector size that is a minimum access unit from the host device, and is set so that the natural number multiple of the cluster size becomes a physical page size. In the case of FIG. 2, one physical page is configured of ten clusters, and one physical block is configured of n physical pages (n being a natural number).

In the management information storing region 122, information including an address conversion table 1221 that stores the management information that manages the storing positions of data in the NAND memory 12, an address conversion table storage position information 1222 that indicates the storing positions of the address conversion table 1221, a valid clusters management table 1223 that indicates a number of valid clusters in each physical block, and an interrupted time writing position information 1224 that is a last media position to which the user data was written upon an occurrence of a factor to interrupt writing (hereinbelow referred to as write interruption factor) such as a power shutdown of the memory system 10, a disconnection of the host interface, or an abort request and the like are stored.

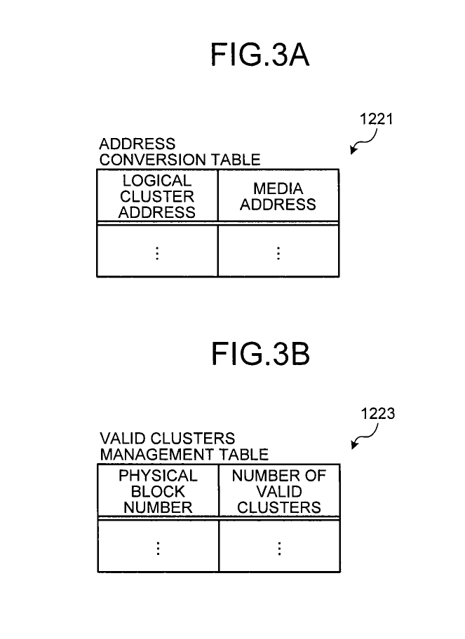

FIG. 3A is a diagram illustrating an example of the address conversion table as the management information. In the NAND memory 12, the storing positions are managed in the units of clusters. The address conversion table 1221 is the management information that associates the logical addresses for data in the units of clusters (hereinbelow referred to as logical cluster addresses) and the physical data storing positions of the data (hereinbelow referred to as media addresses). The logical cluster addresses are addresses that are logically allocated to the storing positions of the data in the NAND memory 12. Further, the media addresses are addresses that are physically allocated in the units of clusters to the storing positions of the data in the NAND memory 12.

FIG. 3B is a diagram illustrating an example of the valid clusters management table as the management information. In the NAND memory 12, the number of clusters in which valid data are stored (valid clusters) is managed in units of physical blocks. The valid clusters management table 1223 associates identifiers (physical block numbers) given to the physical blocks configuring the NAND memory 12 and the number of the valid clusters existing in the physical blocks.

The NAND controller 13 performs interface processing with the NAND memory 12. Here, although details thereof will be omitted, it performs processes such as error correction processing, access control with the NAND memory 12 and the RAM 14 and the like.

The RAM 14 includes a data buffer region 141 that functions as a data transfer buffer between the host device and the NAND memory 12, or as a temporary storage buffer for data to be moved within the NAND memory 12, and a management information storing region 142 that stores the management information that manages the storing positions of the data in the NAND memory 12. The data buffer region 141 includes a read buffer 1411 that temporarily stores the data read from the NAND memory 12 upon a read request from the host device, and a write buffer 1412 that temporarily stores the data to be written to the NAND memory 12 upon a write request from the host device.

The management information storing region 142 includes, as the management information that manages the storing positions of the data in the NAND memory 12 as aforementioned, an address conversion table 1421, and a valid clusters management table 1422. The address conversion table 1421 is configured by a part or an entirety of the address conversion table 1221 of the NAND memory 12 being read out in the management information storing region 142 of the RAM 14 upon a startup of the memory system 10. Further, the valid clusters management table 1422 is also configured by the valid clusters management table 1223 of the NAND memory 12 being read out in the management information storing region 142 of the RAM 14 upon the startup of the memory system 10.

In the embodiment, in a case where a change occurs in the data storing position (the corresponding relationship of the logical cluster address and the media address) due to write of data to the NAND memory 12, or erasure of data in the NAND memory 12 and the like, the management information in the RAM 14 is updated on each occasion, however, a change difference in the management information stored in the NAND memory 12 is accumulated as a log. Due to this, the management information can be restored even in the event of the occurrence of the write interruption factor. Further, the management information stored in the RAM 14 is stored in the NAND memory 12 at a predetermined timing such as when the power of the memory system 10 is turned off and the like, for example.

Notably, as the RAM 14, DRAM (Dynamic RAM), SRAM (Static RAM), FeRAM (Ferroelectric RAM), MRAM (Magnetoresistive RAM), PRAM (Phase change RAM) and the like may be used.

The controller 15 performs data transfer control processing between the host device and the NAND memory 12, or data management processing in the NAND memory 12 and the like. The controller 15 includes a log information generating unit 151, a data processing unit 152, a management information managing unit 153, and a restoration processing unit 154.

The log information generating unit 151 generates log information that assorts write logs indicating the corresponding relationship of the logical cluster addresses and the media addresses in units of clusters for each physical page in a case of writing data in the NAND memory 12. This log information also indicates contents of the change in the address conversion table 1421. In the present embodiment, information that can bring back the management information to a state before atomic processing even if the atomic write processing is interrupted is appended to the write log.

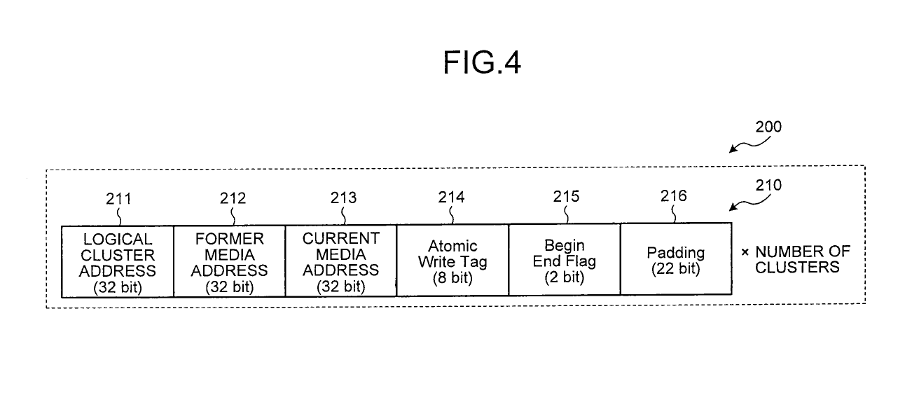

FIG. 4 is a diagram illustrating an example of the log information according to the embodiment. The write log 210 is generated for each cluster. Accordingly, the write logs 210 at a number of the clusters included in one physical page are generated for the one physical page. Further, a collection of the write logs 210 contained in the one physical page becomes log information 200. The log information 200 is written in one cluster within the one physical page. The write log 210 includes a logical cluster address 211, a former media address 212, a current media address 213, an atomic write (Atomic Write) tag 214, a begin (Begin)/end (End) flag 215, and padding data 216.

The logical cluster address 211 is a logical cluster address of the data with which the write log 210 is generated. The former media address 212 and the current media address 213 indicate media addresses before and after the data write to the logical cluster address 211 in the case where the data write such as the atomic write processing and the like is performed. That is, the former media address 212 is the media address that had been associated with the logical cluster address 211 before the data write, and the current media address 213 is the media address that has been associated with the logical cluster address after the data write. These logical cluster address 211, former media address 212, and current media address 213 are stored in the write log in a general memory system 10 that uses the NAND memory 12. Sizes of the logical cluster address 211, the former media address 212, and the current media address 213 may for example be 32 bits.

The atomic write tag 214 is a number (process identifier) that is given each time an atomic write command is issued. The numbers do not overlap among the atomic write commands that are issued concurrently. The atomic write tag 214 may have a size for example of 8 bits. Atomic write is write processing that cannot be stopped once it started. Due to this, when the atomic write command is issued, data of a write target comes to be completely written, or not written. For example, in a case where the write interruption factor occurs in a midst of the atomic write processing, the procedure is returned to a state in which the data that is the write target is not written to the NAND memory 12. That is, the data that is written by the atomic write processing is data that cannot be divided to a smaller size. Such atomic write processing is for example defined by NVM EXPRESS.

The begin/end flags 215 indicate a write state of the data processed by the atomic write command to the NAND memory 12 (state flag). The begin flag is a flag that is attached to a first cluster of the data to be written completely in the NAND memory 12 based on the atomic write command. The end flag is a flag that is attached to a last cluster of the data to be written completely in the NAND memory 12 based on the atomic write command. Notably, no flag is attached to clusters other than the first and the last clusters of the data to be written completely to the NAND memory 12 based on the atomic write command. Since the atomic write command in some cases is issued to data with a size that is equal to or less than one cluster, thus the begin/end flags 215 are 2 bits, which enables to provide the begin flag and the end flag in one cluster.

In performing the atomic write processing, the log information generating unit 151 writes the logical cluster address 211, the former media address 212, and the current media address 213 in the write log 210, and in addition stores the number attached to the atomic write processing in the atomic write tag 214. Further, in a case where the data written in the logical cluster address 211 is a first cluster of the data designated in the atomic write processing, the begin flag is set in the begin/end flag 215, and the end flag is set in the begin/end flag 215 in a case of the last cluster, and no flag is set in the begin/end flag 215 in a case of other clusters.

The padding data 216 is data appended to make the write log 210 be at a predetermined size. The size of the padding data may be 22 bits, when for example the size of the write log 210 is set as 128 bits.

The data processing unit 152 generates a command for the read processing or the write processing including the atomic write command and the like, and performs the processing such as reading the data from the NAND memory 12 or writing the data to the NAND memory 12 based on the generated command. Upon the data write, the write data and the log information corresponding to the write data are written to the physical page of the physical block of the write destination. Notably, the log information is written to the cluster at a predetermined positioning in one physical page (for example, the last cluster).

The management information managing unit 153 manages the management information that changes according to writing and the like of the data to the NAND memory 12 to be latest information. For example, in a case where the media address corresponding to the logical cluster address of the data is changed by writing of the data to the NAND memory 12, the address conversion table 1421 is updated with the new data storing position (media address). Further, the change in the number of valid clusters in the physical block caused by the writing and the like of the data to the NAND memory 12 is stored in the valid clusters management table 1422.

Moreover, the management information managing unit 153 saves the address conversion table 1221, the address conversion table storage position information 1222, the valid clusters management table 1223, and the interrupted time writing position information 1224 in the NAND memory 12 when the write interruption factor occurs. Notably, as for the address conversion table, an operation to write out when a difference amount exceeds a certain threshold is performed during a normal operation, however, the write out processing is performed if further accumulation is occurring.

The restoration processing unit 154 performs a process to return the state of the NAND memory 12, when the write interruption factor occurs during the atomic write processing, to the state in which the write had not been performed. That is, it returns the address conversion table 1221 and the valid clusters management table 1223 to the state before the atomic write processing, and updates the address conversion table storage position information 1222 such so as to indicate the address conversion table 1221 that had been returned to the state before the atomic write processing. Due to this, the data for which writing had been performed only partially due to the occurrence of the write interruption factor upon the atomic write processing is discarded, and the state in which the write has not yet been performed at all can be assumed.

In rollback processing of the address conversion table 1221 and the valid clusters management table 1223, the write data that had been interrupted upon the occurrence of the write interruption factor is extracted, and the state in which that data had not been written to the NAND memory 12 is assumed. Specifically, the log information 200 of the physical page that was being written upon the write interruption is referenced, and the write logs 210 to which the atomic write tags 214 without the end flag are attached are extracted. Further, the address conversion table 1421 is rewound by using the logical cluster addresses 211, the former media addresses 212, and the current media addresses 213 in the extracted write logs 210. This processing is performed in a reversed order from a write order, from the write log 210 that had been written most recently among the extracted write logs 210. That is, when one write log 210 is selected, the media address corresponding to the logical cluster address in the address conversion table 1421 is set as the current media address 213 of the write log 210; thus, a processing to rewrite the current media address 213 to the former media address 212 is performed. At this occasion, in the valid clusters management table 1422, the number of clusters in the physical block that includes the current media address 213 is decremented by one, and the number of valid clusters in the physical block that includes the former media address 212 is incremented by one. This is performed for each of the atomic write tags 214 without the end flag, until the write log 210 having the begin flag is reached. Due to this, the address conversion table 1421 and the valid clusters management table 1422 return to the state before the atomic write processing. Further, when the address conversion table 1421 returns to its original state, user data is also assumed as having returned to its original state.

Further, the address conversion table 1421 that was rewound as above is non-volatilized in the NAND memory 12, and thereupon, the address conversion table storage position information 1222 indicating the position of the address conversion table 1221 that had been non-volatilized is also updated.

Next, rollback processing of the address conversion table 1221, update processing of the address conversion table storage position information 1222, and rollback processing of the valid clusters management table 1223 in the memory system 10 having the aforementioned configuration, will be described. These processes are processes that are performed when the write interruption factor occurs in the middle of the atomic write processing while not all of the data that is the target of the atomic write processing has been written, and thereafter the write interruption factor has resolved (for example, when the power of the memory system 10 is turned on). Notably, rollback processing of the address conversion table 1221 and rollback processing of the valid clusters management table 1223 can be performed concurrently.

### <Rollback Processing of Address Conversion Table>

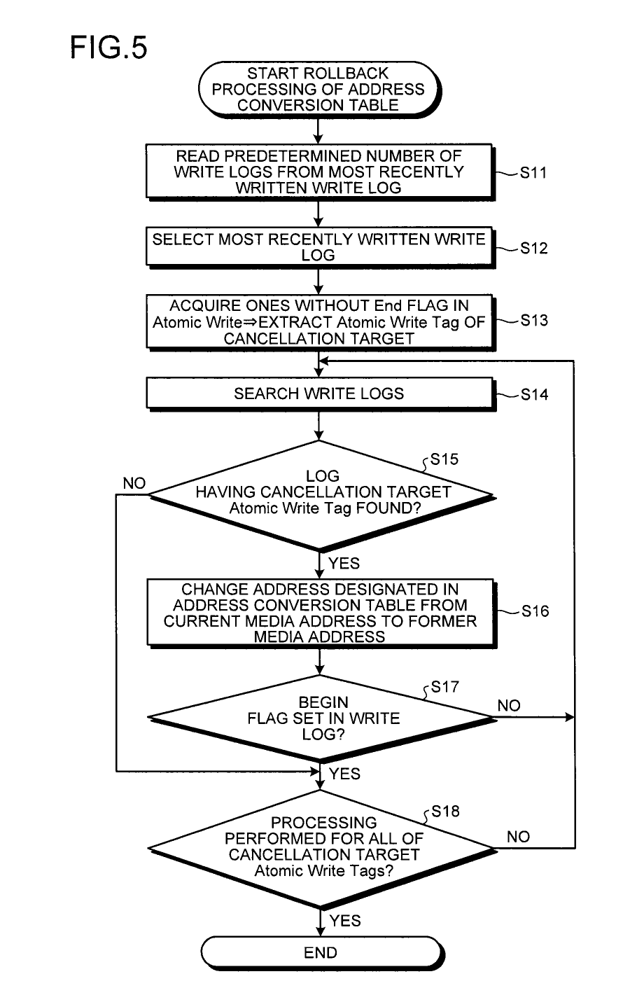

FIG. 5 is a flow chart illustrating an example of a procedure of the rollback processing of the address conversion table according to the embodiment. Firstly, the restoration processing unit 154 extracts the address conversion table 1221 in the NAND memory 12 based on the address conversion table storage position information 1222 that indicates the position of the latest address conversion table 1221 at the time of the occurrence of the write interruption factor, and restores the same in the management information storing region 142 of the RAM 14 for example.

Then, the restoration processing unit 154 reads out a predetermined number of write logs from within the write logs 210 that had been written most recently at the time of the occurrence of the write interruption factor based on the interrupted time writing position information 1224 (step S11). Thereafter, the write logs 210 that had been written most recently are selected (step S12). Then, from among the selected write logs 210, ones that indicate the atomic write processing and do not have the end flag are acquired, and the atomic write tags 214 of those write logs 210 are extracted as atomic write tags 214 that are targets of cancellation (step S13).

Notably, since the atomic write processing is performed concurrently in parallel, there are cases in which the atomic write tags 214 that are targets of cancellation may not only be one, but a plurality may exist. Due to this, by using the predetermined number of write logs 210 read in the step S11, the case in which a plurality of atomic write tags 214 that being the targets of cancellation exists can be dealt with.

Next, the write logs 210 are searched (step S14), and a determination is made on whether a write log 210 having the atomic write tag 214 that is the target of cancellation is found (step S15).

In a case where the write log 210 having the atomic write tag 214 that is the target of cancellation is found (in the case of Yes in step S15), the logical cluster address 211 and the former media address 212 are acquired. Then, the media address in the restored address conversion table 1421 corresponding to the acquired logical cluster address 211 is changed to the acquired former media address 212 (step S16). Then, a determination is made on whether the begin flag had been set to the write log 210 (step S17).

In a case where the begin flag is not set in the write log 210 (in the case of No in step S17), the process returns to step S14. Further, in a case where the begin flag is set in the write log 210 (in the case of Yes in step S17) or in a case where a write log 210 having the atomic write tag 214 that is the target of cancellation was not found in step S15 (in the case of No in step S15), a determination is made on whether the processing has been performed for all of the atomic write tags 214 that are the targets of cancellation (step S18). In a case where the processing has not yet been performed for all of the atomic write tags 214 that are the targets of cancellation (in the case of No in step S18), the process returns to step S14, and the processes from step S14 to step S17 are performed for the subsequent atomic write tag 214. Further, in the case where the processing is performed for all of the atomic write tags 214 that are the targets of cancellation (in the case of Yes in step S18), the rollback processing ends since the address conversion table 1421 restored in the RAM 14 has returned to the state before the execution of the atomic write processing.

### <Update Processing of Address Conversion Table Storage Position Information>

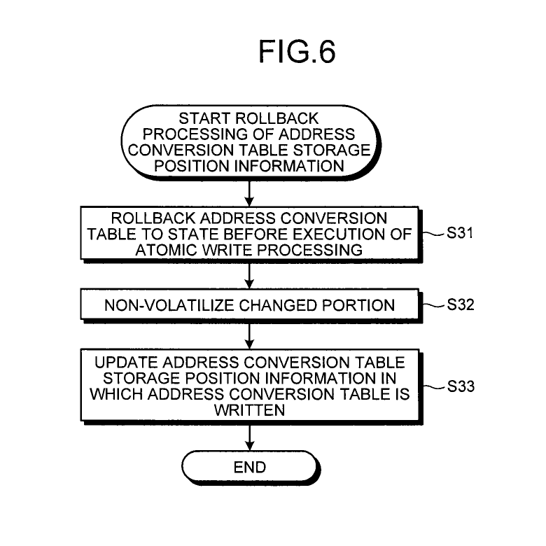

FIG. 6 is a flow chart illustrating an example of a procedure of the rollback processing of the address conversion table storage position information. When the rollback processing of the address conversion table 1421 to the state before the execution of the atomic write processing on the RAM 14 in accordance with the process procedure illustrated in FIG. 5 is ended (step S31), the restoration processing unit 154 non-volatilizes the changed portion (step S32). That is, a process to store the address conversion table 1421 to which the change has been reflected in the management information storing region 122 of the NAND memory 12 is performed. Thereafter, the restoration processing unit 154 updates the address conversion table storage position information 1222 that is the storing position of the address conversion table 1221 to which the change has been reflected in the NAND memory 12 (step S33), and the process ends.

### <Rollback Processing of Valid Clusters Management Table>

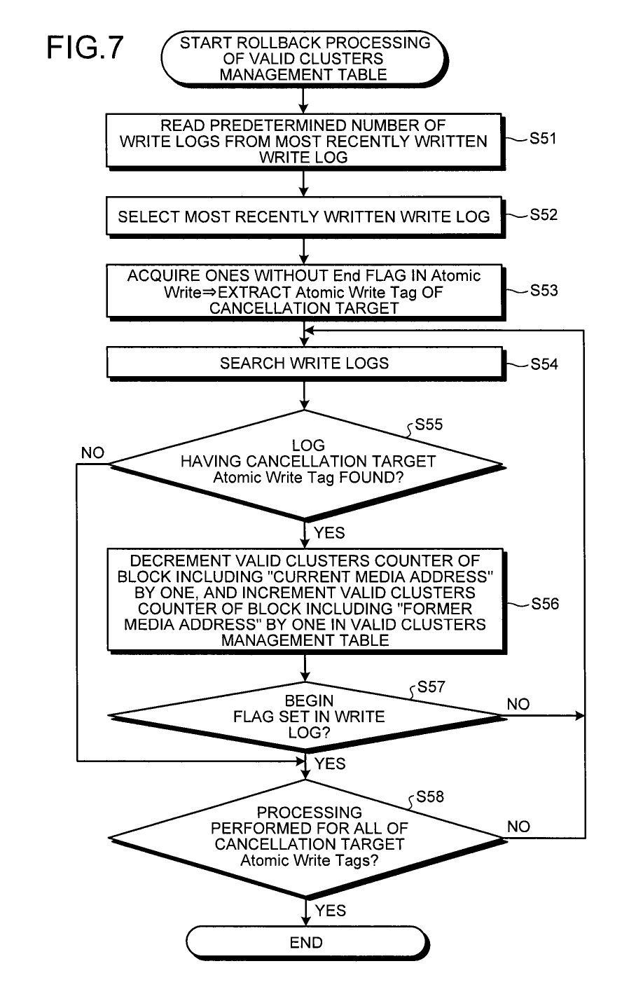

FIG. 7 is a flow chart illustrating an example of a procedure of the rollback processing of the valid clusters management table according to the embodiment. Firstly, the restoration processing unit 154 extracts the address conversion table 1221 in the NAND memory 12 based on the address conversion table storage position information 1222 that indicates the position of the latest address conversion table upon the occurrence of the write interruption factor, and restores the same in the management information storing region 142 of the RAM 14 for example.

Then, the restoration processing unit 154 performs the processes similar to steps S11 to S15 of FIG. 5 to extract the atomic write tags 214 that are the targets of cancellation from the predetermined number of write logs read from the write logs 210 that was written most recently upon the occurrence of the write interruption factor, and determines whether the write log 210 having the atomic write tag 214 that is the target of cancellation has been found (steps S51 to S55).

In a case where the write log 210 having the atomic write tag 214 that is the target of cancellation was found (in the case of Yes in step S55), a correction is performed on a number (valid clusters) of clusters in which valid data is included within the physical block managed by the valid clusters management table 142. Specifically, the cluster to which data is written by the execution process of the atomic write command is a valid cluster including valid data in the state before the occurrence of the write interruption factor. However, since the atomic write is either all of the data has been written or all of the data was not written, as aforementioned, the data in the middle of writing is dealt as that the data was not written at all in the state after the occurrence of the write interruption factor. As a result, in the state after the occurrence of the write interruption factor, the cluster including the data of which writing was interrupted in the middle of the atomic write processing is regarded as an invalid cluster. Further, the physical address of the data to be written in the atomic write processing is stored in the write log 210 as the current media address 213, and the physical address that was associated with the logical cluster address 211 before the writing is stored in the write log 210 as the former media address 212. Since those with which the data was not written in the state after the occurrence of the write interruption factor are returned to the state before the atomic write processing; thus, a process to decrement the valid clusters counter of the physical block having the cluster designated by the current media address 213 to which the data is written upon the atomic write processing, and increment the valid clusters counter of the physical block having the cluster designated by the former media address 212 before the atomic write processing is performed. Here, since the process is executed for one write log at a time, the valid clusters counter of the physical block having the cluster designated by the current media address 213 in the write log 210 is decremented by one, and the valid clusters counter of the physical block having the cluster designated by the former media address 212 is incremented by one (step S56).

Then, a determination is made on whether the begin flag had been set to the write log 210 (step S57). In a case where the begin flag is not set in the write log 210 (in the case of No in step S57), the process returns to step S54. Further, in a case where the begin flag is set in the write log 210 (in the case of Yes in step S57) or in a case where a write log 210 having the atomic write tag 214 that is the target of cancellation was not found in step S55 (in the case of No in step S55), a determination is made on whether the processing has been performed for all of the atomic write tags 214 that are the targets of cancellation (step S58). In a case where the processing has not yet been performed for all of the atomic write tags 214 that are the targets of cancellation (in the case of No in step S58), the process returns to step S54, and the processes from step S54 to step S57 are performed for the subsequent atomic write tag 214. Further, in the case where the processing is performed for all of the atomic write tags 214 that are the targets of cancellation (in the case of Yes in step S58), the rollback processing ends since the valid clusters management table 1422 restored in the RAM 14 has returned to the state before the execution of the atomic write processing.

In the present embodiment, the atomic write tags 214 and the begin/end flags 215 are provided to the write logs 210 of the user data, stores the numbers appended upon the atomic write processing in the atomic write tags 214, sets the begin flag in the first data (cluster) of the atomic write processing, and sets the end flag in the last data (cluster). Due to this, even in the case where the write interruption factor occurs during the execution of the atomic write processing, and thereafter the write interruption factor is resolved (for example, when the memory system 10 is started), the advantageous effect can be achieved in that the address conversion table 1221 can be brought back to the state before the execution of the atomic write processing by tracing the write logs 210 in the log information 200 back.

Further, since the atomic write tag 214 and the begin/end flag 215 for example have an information amount altogether of about 10 bits, burden on the creation of the write logs 210 hardly increases compared to the conventional case, and scarcely no influence is imposed on a normal operation of the memory system 10. As a result, an advantageous effect is achieved in that a performance deterioration upon installing the atomic write function is prevented.

Moreover, since time during which additional processing needs to be performed especially upon the occurrence of the write interruption factor is not required, there is no risk that an inconsistency occurs due to not being able to save address update information.

Further, in the case where the storage medium is configured of the NAND memory 12, since the rollback processing of the valid clusters management table 1223 is also performed after the atomic write processing has been interrupted and then the write interruption factor has been resolved, accuracy in the valid clusters of each physical block can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile first memory in which a position management of stored data is performed at a first size, access to data is performed at a second size, the second size being a natural number multiple of the first size, and erasure of data is performed at a third size, the third size being a natural number multiple of the second size;
a second memory configured to temporarily store data transmitted and received between a host device and the first memory, or data moved within the first memory;
a third memory including address conversion information that associates, with regard to the data stored in the first memory, a logical address logically allocated within the first memory by the first size and a physical address physically allocated within the first memory by the first size; and
a controller configured to perform data transfer between the first memory and the second memory,
wherein the controller includes:
a log information generating unit configured to generate log information, the log information being write logs collected in a predetermined size, the write logs including a change in the physical address relative to the logical address for each first size before and after writing of a write target by an atomic write process, and a process identifier that identifies the atomic write process, wherein the atomic write process completely writes the write target or returns the write target to a state in which the write target has not been written at all when an interruption has occurred during the writing;
a data processing unit configured to write, in the first memory, the write target of the atomic write process and the corresponding log information, as write data of the second size; and
a restoration processing unit configured to extract, when the interruption has occurred during the atomic write process and the memory system has recovered from the interruption, a first process identifier appended to the interrupted atomic write process, from the log information in the write data, and restore the address conversion information to a state before the atomic write process by using the write logs including the first process identifier.

2. The memory system according to claim 1, wherein
the log information generating unit writes a state of the atomic write process of data of the first size to a state flag of the corresponding write logs, and
the restoration processing unit extracts the first process identifier that does not have the state flag indicating an end, and restores the address conversion information by using the write logs, the write logs including the first process identifier.

3. The memory system according to claim 2, wherein the restoration processing unit restores the address conversion information by selecting sequentially, from among the write logs including the first process identifier, one with a more recent write order to one with an older write order.

4. The memory system according to claim 2, wherein
the third memory further includes valid data number management information, the valid data number management information indicating, for each storing region of the third size, a number of storing regions of the first size in which valid data is stored, and
the restoration processing unit further performs a process to restore the valid data number management information to a state before the atomic write process by using the write logs including the first process identifier among the log information of the data of the second size in which the atomic write process has been interrupted.

5. The memory system according to claim 4, wherein, as a restoration process of the valid data number management information, the restoration processing unit decrements, by one, a number of valid data in the storing region of the third size, the storing region of the third size including the physical address after the atomic write process among the write logs including the first process identifier, and increments, by one, the number of valid data in the storing region of the third size, the storing region of the third size including the physical address before the atomic write process.

6. The memory system according to claim 1, wherein the first memory is a NAND type flash memory.

7. A controller that performs data transfer between a first memory and a second memory, the first memory being a non-volatile memory in which a position management of stored data is performed at a first size, access to data is performed at a second size, the second size being a natural number multiple of the first size, and erasure of data is performed at a third size, the third size being a natural number multiple of the second size, the controller storing a result of the data transfer in address conversion information in a third memory,
the address conversion information being information that associates, with regard to the data stored in the first memory, a logical address logically allocated within the first memory by the first size and a physical address physically allocated within the first memory by the first size,
the controller further comprising:
a log information generating unit configured to generate log information, the log information being write logs collected in a predetermined size, the write logs including a change in the physical address relative to the logical address for each first size before and after writing of a write target by an atomic write process, and a process identifier that identifies the atomic write process, wherein the atomic write process completely writes the write target or returns the write target to a state in which the write target has not been written at all when an interruption has occurred during the writing;
a data processing unit configured to write, in the first memory, the write target of the atomic write process and the corresponding log information, as write data of the second size; and
a restoration processing unit configured to extract, when the interruption has occurred during the atomic write process and the memory system has recovered from the interruption, a first process identifier appended to the interrupted atomic write process, from the log information in the write data, and restore the address conversion information to a state before the atomic write process by using the write logs including the first process identifier.

8. The controller according to claim 7, wherein
the log information generating unit writes a state of the atomic write process of data of the first size to a state flag of the corresponding write logs, and
the restoration processing unit extracts the first process identifier that does not have the state flag indicating an end, and restores the address conversion information by using the write logs, the write logs including the first process identifier.

9. The controller according to claim 8, wherein the restoration processing unit restores the address conversion information by selecting sequentially, from among the write logs including the first process identifier, one with a more recent write order to one with an older write order.

10. The controller according to claim 8, wherein
the third memory further includes valid data number management information, the valid data number management information indicating, for each storing region of the third size, a number of storing regions of the first size in which valid data is stored, and
the restoration processing unit further performs a process to restore the valid data number management information to a state before the atomic write process by using the write logs including the first process identifier among the log information of the data of the second size in which the atomic write process has been interrupted.

11. The controller according to claim 10, wherein, as a restoration process of the valid data number management information, the restoration processing unit decrements, by one, a number of valid data in the storing region of the third size including the physical address after the atomic write process among the write logs including the first process identifier, and increments, by one, the number of valid data in the storing region of the third size, the storing region of the third size including the physical address before the atomic write process.

12. The controller according to claim 7, wherein the first memory is a NAND type flash memory.

13. A method of controlling a memory system that includes:
a non-volatile first memory in which a position management of stored data is performed at a first size, access to data is performed at a second size, the second size being a natural number multiple of the first size, and erasure of data is performed at a third size, the third size being a natural number multiple of the second size;
a second memory configured to temporarily store data transmitted and received between a host device and the first memory, or data moved within the first memory;
a third memory including address conversion information that associates, with regard to the data stored in the first memory, a logical address logically allocated within the first memory by the first size and a physical address physically allocated within the first memory by the first size; and
a controller configured to perform data transfer between the first memory and the second memory,
the method comprising:
generating log information, the log information being write logs collected in a predetermined size, the write logs including a change in the physical address relative to the logical address for each first size before and after writing of a write target by an atomic write process, and a process identifier that identifies the atomic write process, wherein the atomic write process completely writes the write target or returns the write target to a state in which the write target has not been written at all when an interruption has occurred during the writing;
writing, in the first memory, the write target of the atomic write process and the corresponding log information, as write data of the second size;
extracting, when the interruption has occurred during the atomic write process and the memory system has recovered from the interruption, a first process identifier, from the log information in the write data that was being written at the time of the interruption; and
restoring the address conversion information to a state before the atomic write process by using the write logs including the first process identifier.

14. The method of controlling the memory system according to claim 13, wherein
in the generation of the log information, a state of the atomic write process of data of the first size is written to a state flag of the corresponding write logs, and
in the restoration of the address conversion information, the first process identifier that does not have the state flag indicating an end, is extracted, and the address conversion information is restored by using the write logs, the write logs including the first process identifier.

15. The method of controlling the memory system according to claim 14, wherein in the restoration of the address conversion information, a restoration process of the address conversion information is performed by selecting sequentially, from among the write logs including the first process identifier, one with a more recent write order to one with an older write order.

16. The method of controlling the memory system according to claim 14, further comprising:
restoring valid data number management information to a state before the atomic write process by using the write logs including the first process identifier among the log information of the data of the second size in which the atomic write process has been interrupted, wherein
the valid data number management information is information that indicates, for each storing region of the third size, a number of storing regions of the first size in which valid data is stored, and that is stored in the third memory.

17. The method of controlling the memory system according to claim 16, wherein
in the restoration of the valid data number management information, a number of valid data in the storing region of the third size including the physical address after the atomic write process among the write logs including the first process identifier is decremented by one, and the number of valid data in the storing region of the third size including the physical address before the atomic write process is incremented by one.
